(19) United States
(12) Patent Application Publication
(10) Pub. No.: US 2009/0167727 A1
(43) Pub. Date: Jul. 2, 2009

(54) STYLUS AND ELECTRONIC DEVICE

(75) Inventors: Yi-Ching Liu, Taoyuan County (TW); Hsu-Hsiang Tseng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/335,539

(22) Filed: Dec. 16, 2008

(30) Foreign Application Priority Data
Dec. 28, 2007 (TW) 96151019

(51) Int. Cl. G06F 3/033

(52) U.S. Cl. 345/179

(57) ABSTRACT

An electronic device including a device body and a stylus is provided. The device body has a capacitive touch panel. The stylus has a handle and a head. The head is magnetic. The capacitive touch panel is controlled by the stylus through magnetism of the head.

### CROSS-REFERENCE TO RELATED APPLICATION

This application claims the priority benefit of Taiwan application serial no. 96151019, filed Dec. 28, 2007. The entirety of the above-mentioned patent application is hereby incorporated by reference herein and made a part of this specification.

### BACKGROUND

1. Field of the Invention

The present application generally relates to a stylus and an electronic device using the stylus, in particular, to a stylus with a magnetic head and an electronic device using the stylus.

2. Description of Related Art

With the rapid development of technology, most manufacturers of electronic devices such as notebook computers, mobile phones, or portable multimedia players start to use touch panels to replace conventional keyboards to serve as input interfaces of a new generation. Particularly, the current touch panels are generally classified into capacitive touch panels and resistive touch panels. Taking iPhone available from Apple Inc. as an example, the iPhone uses a capacitive touch panel as the input interface, and a user can input words or select a certain option on a menu merely through a finger.

However, in order to cater to the user's operation mode of using a finger, icons displayed on a screen must be configured in an appropriate size to prevent the user from miss touching the icons. Furthermore, a part of the screen is often shielded by finger of the user when the capacitive touch panel is used. Moreover, a conventional stylus has a small head, so that a user can click small icons conveniently, but the conventional stylus is only applicable to resistive touch panels, but not applicable to capacitive touch panels.

### SUMMARY OF THE INVENTION

Accordingly, the present application is directed to a stylus for operating a capacitive touch panel.

The present application is also directed to an electronic device, which uses a stylus to operate a capacitive touch panel.

The present application provides a stylus, which is adapted to control a capacitive touch panel. The stylus has a handle and a head. The head is magnetic.

The present application provides an electronic device, which includes a device body and a stylus. The device body has a capacitive touch panel. The stylus has a handle and a head. The head is magnetic. The stylus is used for controlling the capacitive touch panel of the body.

To sum up, the head of the stylus of the present application is magnetic. Therefore, when a relative speed exists between the head and the capacitive touch panel, an inducting current is generated on the capacitive touch panel. Then, the capacitive touch panel calculates a position where the inducting current is generated according to the inducting current. Thus, the stylus can control the capacitive touch panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic views of two operating states of an electronic device according to an embodiment of the present invention.

FIGS. 2A and 2B are schematic views of two distribution modes of magnetic poles of a stylus.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

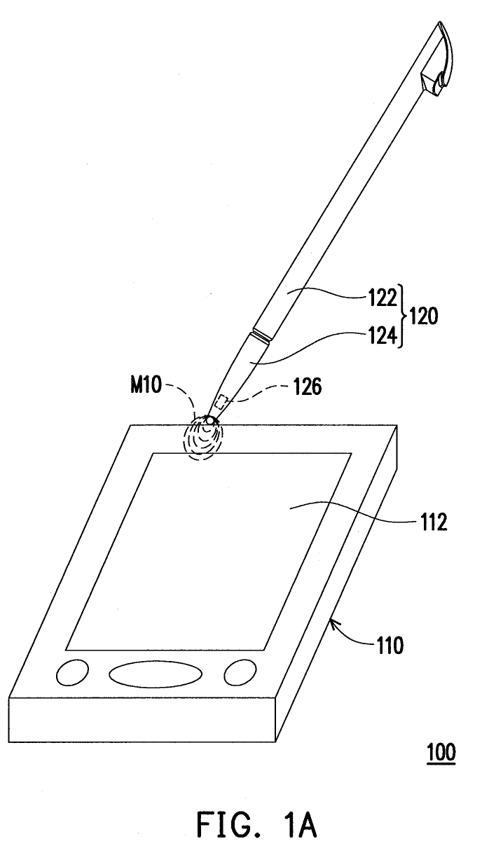

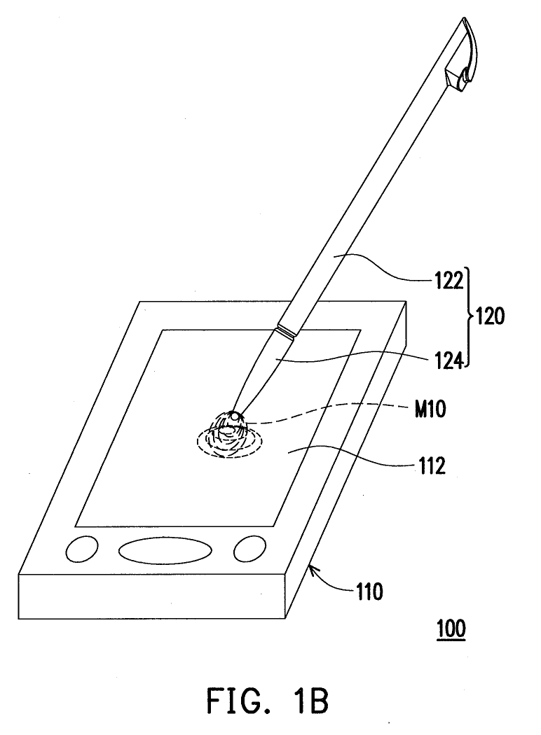

FIGS. 1A and 1B are schematic views of two operating states of an electronic device according to an embodiment of the present invention. Referring to FIG. 1A, an electronic device 100 according to this embodiment includes a device body 110 and a stylus 120. In this embodiment, the electronic device 100 may be a personal digital assistant (PDA), an ultra mobile PC (UMPC), a smart phone, a handheld mobile phone, or another electronic device with a touch control function. The device body 110 has a capacitive touch panel 112. The stylus 120 has a handle 122 and a head 124. The head 124 is magnetic. Here, the handle 122 and the head 124 are not limited to independent components, but may be formed integrally. The handle 122 is held by a user, and the head 124 approaches the capacitive touch panel 112 in use. The head 124 may be made of a magnetic material, or may be provided with a magnet 126 at a tip of the head 124.

When a relative speed exists between the head 124 of the stylus 120 and any region of the capacitive touch panel 112, an inducting current is generated on the region of the capacitive touch panel 112 due to magnetic force lines M10 of the head 124, as shown in FIG. 1B. Thus, the capacitive touch panel 112 can calculate the position where the inducting current is generated. In other words, the magnetic stylus 120 can be used to operate the capacitive touch panel 112. Compared with a conventional electronic device having a capacitive touch panel that can be operated only with a finger, the magnetic stylus 120 according to this embodiment can operate the capacitive touch panel 112, so that the icons on the capacitive touch panel 112 may be configured into a smaller size, thereby reducing the possibility of miss touching the icons. In addition, when a user uses the magnetic stylus 120 to operate the capacitive touch panel 112, the user can see the icons on the capacitive touch panel 112 clearly.

In this embodiment, the handle 122 and the head 124 are both conductive; however, the present embodiment is not limited hereby. If the handle 122 and the head 124 are both conductive, when the user holds the handle 122, the electric field of the user is different from that of the capacitive control panel 112. Thus, when the stylus 120 approaches the capacitive touch panel 112, the inducting current is generated on the capacitive touch panel 112, which improves the success rate of the operations on the electronic device 100 through using the stylus 120. In the present embodiment, the handle 122 and the head 124 are both conductive, which indicates that the handle 122 and the head 124 can provide a conductive path with a resistance lower than a resistance of a human body. In addition, for example, the handle 122 may be made of a metal or another conductive material. However, the handle 122 may also be formed by an insulating main body (not shown) and a conductive layer (not shown) enveloping the insulating main body. The insulating main body may be made of plastics or other insulating materials, especially insulating materials with a low cost. The conductive layer may be made of a metal or another appropriate conductive material, which envelops the insulating main body through electroplating or another appropriate manner.

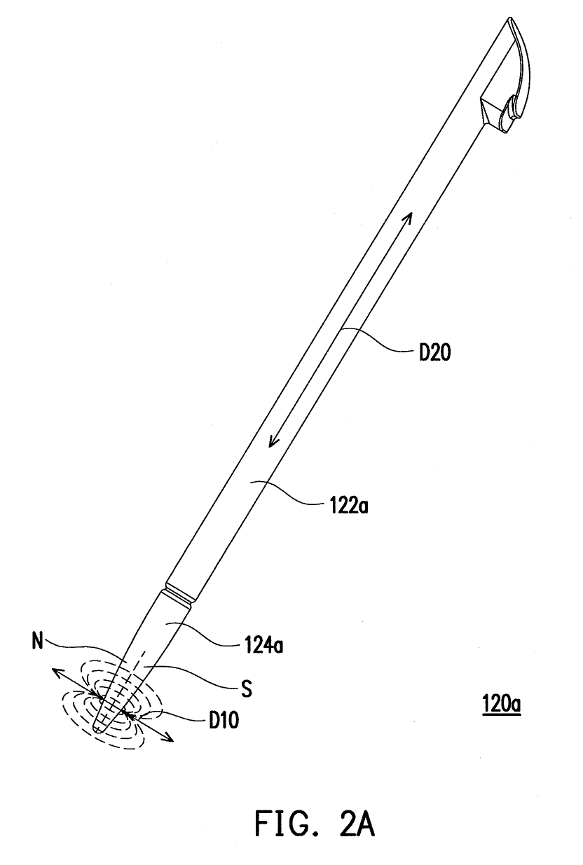

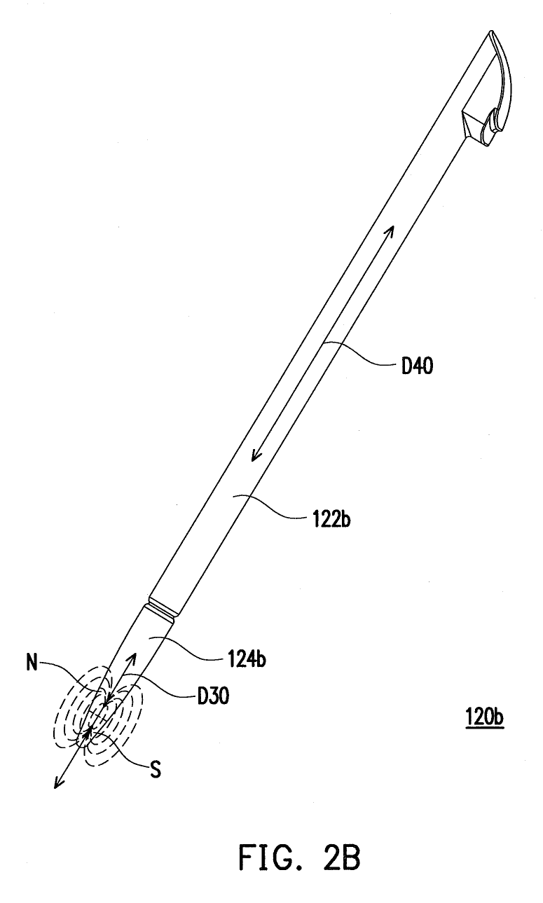

FIGS. 2A and 2B are schematic views of two distribution modes of magnetic poles of a stylus. Referring to FIG. 2A, a connecting line D10 between magnetic poles N and S of a head 124a of a stylus 120a is substantially perpendicular to a lengthwise direction D20 of a handle 122a. Alternatively, referring to FIG. 2B, a connecting line D30 between magnetic poles N and S of a head 124b of a stylus 120b is substantially parallel to a lengthwise direction D40 of a handle 122b. The two distribution modes of the magnetic poles described above are only exemplary. The magnetic poles of the stylus of the present invention may also be distributed in other modes.

To sum up, the stylus of the present application has a magnetic head. When a relative speed exists between the stylus and the capacitive touch panel, an inducting current is generated on the capacitive touch panel, and the capacitive touch can calculate the position where the inducting current is generated according to the inducting current. Thus, the stylus can control the capacitive touch panel. In addition, the head of the stylus is smaller than fingers, so the stylus does not shield the sight of the user, and thus smaller icons are also applicable.

It will be apparent to persons of ordinary art in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stylus, adapted to control a capacitive touch panel, comprising a handle and a head, wherein the head is magnetic.

2. The stylus according to claim 1, wherein a connecting line between two magnetic poles of the head is substantially perpendicular to a lengthwise direction of the handle.

3. The stylus according to claim 1, wherein a connecting line between two magnetic poles of the head is substantially parallel to a lengthwise direction of the handle.

4. The stylus according to claim 1, wherein the handle and the head are conductive.

5. The stylus according to claim 4, wherein the handle is made of a conductive material.

6. The stylus according to claim 4, wherein the handle comprises an insulating main body and a conductive layer enveloping the insulating main body.

7. An electronic device, comprising:
a device body, comprising a capacitive touch panel; and
a stylus, for controlling the capacitive touch panel, and comprising a handle and a head, wherein the head is magnetic.

8. The electronic device according to claim 7, wherein a connecting line between two magnetic poles of the head is substantially perpendicular to a lengthwise direction of the handle.

9. The electronic device according to claim 7, wherein a connecting line between two magnetic poles of the head is substantially parallel to a lengthwise direction of the handle.

10. The electronic device according to claim 7, wherein the handle and the head are conductive.

11. The electronic device according to claim 10, wherein the handle is made of a conductive material.

12. The electronic device according to claim 10, wherein the handle comprises an insulating main body and a conductive layer enveloping the insulating main body.
